(19) United States
(12) Patent Application Publication
(10) Pub. No.: US 2020/0093670 A1
(43) Pub. Date: Mar. 26, 2020

(54) DETACHABLE BED RAIL

(71) Applicant: Stander Inc., Logan, UT (US)

(72) Inventors: F. Troy Miller, Logan, UT (US); Adam Daniel Scott, Providence, UT (US)

(21) Appl. No.: 16/137,142

(22) Filed: Sep. 20, 2018

(51) Int. Cl. A61G 7/05

(52) U.S. Cl. CPC A61G 7/0509; A61G 7/052; A61G 7/0514

(57) ABSTRACT

A detachable bed rail providing support for a user on a bed or similar furniture is disclosed. The detachable bed rail may include a base that can fit under a mattress, and a support rail that extends upright relative to the base. The bed rail may be decoupled from the base portion and coupled to the bed in a storage configuration. The detachable bed rail may include accessories comprising a rail cover, a tray table and an attachable extension.

### TECHNICAL FIELD

The present disclosure relates generally to mobility assistance devices. More specifically, the present disclosure relates to assistance devices, such as bed rail devices, that can assist individuals in positioning themselves onto and securing themselves on beds or similar furniture.

### BRIEF DESCRIPTION OF THE DRAWINGS

The embodiments disclosed herein will become more fully apparent from the following description and appended claims, taken in conjunction with the accompanying drawings. These drawings depict only typical embodiments, which will be described with additional specificity and detail through use of the accompanying drawings in which:

FIG. 1 is a perspective view of a first embodiment of a detachable bed rail;

FIG. 2 is a perspective view of the detachable bed rail of FIG. 1, with the support rail portion separated from the base portion;

FIG. 3A is a perspective view of the detachable bed rail of FIG. 1, with a securement strap shown in an unsecured state;

FIG. 3B is a perspective view of the detachable bed rail of FIG. 1, with the securement strap shown in a secured state;

FIG. 4A is an exploded perspective view of a bed with the detachable bed rail of FIG. 1 decoupled from the base portion;

FIG. 4B is a perspective view of a bed with the detachable bed rail of FIG. 1 disposed in a storage configuration;

FIG. 4C is a perspective view of a bed attachment member of the detachable bed rail of FIG. 1;

FIG. 5A is a perspective view of a tray table accessory attached to a support rail member of the detachable bed rail of FIG. 1;

FIG. 5B is a perspective view of a tray table accessory disengaged from a rail member of the detachable bed rail of FIG. 1;

FIG. 5C is a detailed exploded perspective view of the tray table accessory attached to the detachable bed rail of FIG. 1;

FIG. 5D is a detailed exploded perspective view of an attachment clamp for attachment of accessories to the detachable bed rail of FIG. 1;

FIG. 6A is a perspective view of a first embodiment of a rail cover;

FIG. 6B is a perspective view of the first embodiment of a rail cover when attached to the support rail portion of the detachable bed rail of FIG. 1;

FIG. 6C is a perspective view of a second embodiment of a rail cover;

FIG. 6D is a perspective view of the second embodiment of a rail cover when attached to the support rail portion of the detachable bed rail of FIG. 1;

FIG. 7 is a perspective view of a rail extension attached to the support rail portion of the detachable bed rail of FIG. 1;

FIG. 8 is a perspective view of a second embodiment of a detachable bed rail;

FIG. 9 is a top perspective view of the first embodiment of the detachable bed rail;

FIG. 10 is a bottom perspective view of the first embodiment of the detachable bed rail;

FIG. 11 is a front view of the first embodiment of the detachable bed rail;

FIG. 12 is a back view of the first embodiment of the detachable bed rail;

FIG. 13 is a right side view of the first embodiment of the detachable bed rail;

FIG. 14 is a left side view of the first embodiment of the detachable bed rail;

FIG. 15 is a top view of the first embodiment of the detachable bed rail;

FIG. 16 is a bottom view of the first embodiment of the detachable bed rail;

FIG. 17 is a top perspective view of the second embodiment of the detachable bed rail;

FIG. 18 is a bottom perspective view of the second embodiment of the detachable bed rail;

FIG. 19 is a front view of the second embodiment of the detachable bed rail;

FIG. 20 is a back view of the second embodiment of the detachable bed rail;

FIG. 21 is a right side view of the second embodiment of the detachable bed rail;

FIG. 22 is a left side view of the second embodiment of the detachable bed rail;

FIG. 23 is a top view of the second embodiment of the detachable bed rail; and

FIG. 24 is a bottom view of the second embodiment of the detachable bed rail.

### DETAILED DESCRIPTION

It will be readily understood that the components of the embodiments as generally described and illustrated in the figures herein could be arranged and designed in a wide variety of different configurations. Thus, the following more detailed description of various embodiments, as represented in the figures, is not intended to limit the scope of the invention, as claimed, but is merely representative of various embodiments. While the various aspects of the embodiments are presented in drawings, the drawings are not necessarily drawn to scale unless specifically indicated.

The phrases “connected to,” “coupled to” and “in communication with” refer to any form of interaction between two or more entities, including mechanical, electrical, magnetic, electromagnetic, fluid, and thermal interaction. Two components may be coupled to each other even though they are not in direct contact with each other. For example, two components may be coupled to each other through an intermediate component.

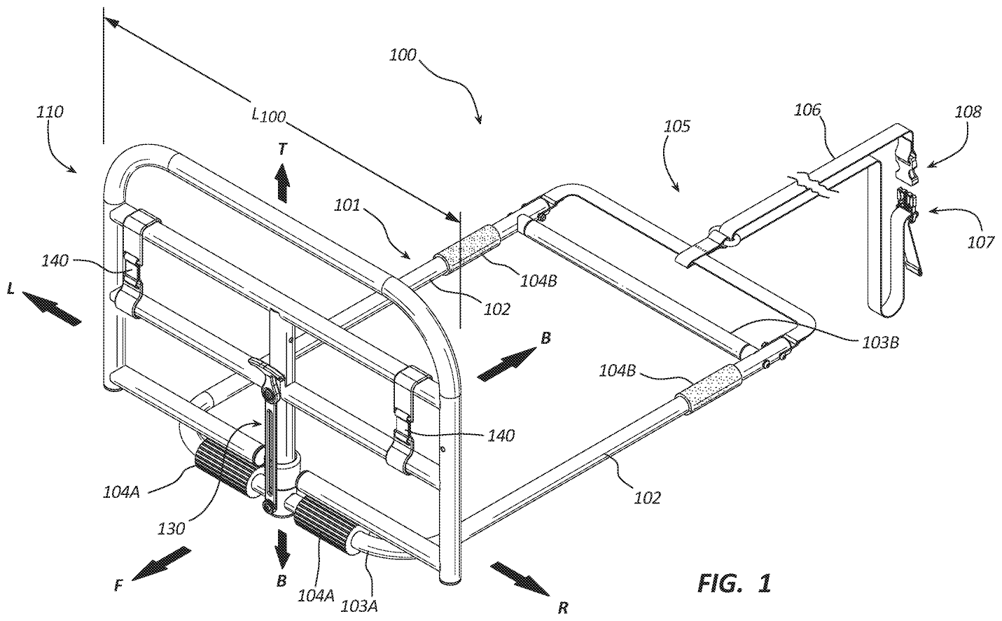

FIG. 1 represents a first embodiment of a detachable bed rail 100 as shown from a perspective view. Bed rails are a form of a mobility assistance device and are typically used to assist individuals with disabilities and/or other infirmities that may be incident to accidents, disease, age or similar causes. Bed rails are designed to help these individuals get into and out of reclining, sitting and/or prone positions on a bed or similar piece of furniture or object designed for one to sit, lie down or sleep on. Furthermore, bed rails also serve the function of securing an individual in a bed so that they do not fall out accidentally. Bed rails may also comprise accessories to provide added uses and convenience.

For purposes of illustration and reference and not by way of limitation, FIG. 1 indicates sides of the detachable bed rail 100, i.e. top, bottom, front, back, right, and left. Reference to the indicated sides may be made in relation to and thus apply to subsequent figures even though the sides may not be repeatedly indicated in the subsequent figures.

The detachable bed rail 100 may include a base portion 101, a support rail portion 110, and an attachment member 105. In one embodiment, the base portion 101 of the detachable bed rail 100 is designed to fit between a mattress and box spring of a bed, or underneath the cushion of a couch or similar furniture. The base portion 101 provides support for the support rail portion 110 when a user pulls or pushes thereon.

According to the embodiment depicted, the base portion 101 may include legs 102 that are optionally parallel to each other and optionally interconnected by one or more crossbars 103A, 103B. However, in alternative embodiments, the base portion 101 may include a planar member having dimensions to fit between a mattress and box spring of a bed. Those having skill in the art with the aid of the present disclosure will recognize that various configurations and designs of the base portion may be used to provide the necessary support for the support rail portion 110, including, but not limited to, a base portion 101 designed to extend down to the floor, or underneath both the mattress and box spring, or coupled to a bed frame.

The attachment member 105 may comprise a strap 106 of nylon, fabric, or similar construction that is coupled to the base portion 101, for example at the end furthest away from the support rail portion 110, such as adjacent the crossbar 1036. The attachment member 105 may be used as an anchoring mechanism to prevent the base portion 101 from slipping out from between the mattress and the box spring of the bed. The attachment member 105 may be designed to extend between the mattress and box spring and be secured to the bed frame or similar structure. The attachment member 105 may comprise an anchoring member 107 such as a loop, a hook or any other suitable mechanism for attachment to the bed frame. Alternatively, the attachment member 105 may be anchored to the mattress and/or box spring. The attachment member 105 may also include a buckle 108 to facilitate coupling of ends of the strap 106 and adjusting the length of the strap 106 so that it may fit various sizes and types of beds. The attachment member 105 may then be tightened through the adjustment buckle 108 in a manner that prevents the base portion 101 from slipping out from between the mattress and box spring.

The base portion 101 may also comprise features that inhibit sliding of the base portion 101 relative to the mattress. For example, the base portion 101 may comprise a non-slip coating or surface finish on the surfaces that contact the bed or mattress, such as the legs 102 and the crossbars 103A, 103B. In the current embodiment, a pair of sleeves 104B is disposed on the legs 102. The sleeves 104B are shaped to provide enhanced engagement of the legs 102 with the bed or mattress and are formed of a material to provide added friction to the bedding materials. The sleeves 104B are disposed at a location along the lengths of the legs 102 so as to take advantage of a user's weight when sitting or lying on the mattress.

The base portion 101 may also comprise one or more bumpers 104A on the crossbar 103A to prevent direct contact between the crossbar 103A and a rigid portion of the bed such as the bed frame. The bumpers 104A may be formed of a soft material to prevent marring, scratching or other damage to the bed frame.

In further reference to FIG. 1, the support rail portion 110 of the embodiment depicted is coupled to the base portion 101 defining a first or operational configuration. When coupled, the support rail portion 110 may extend above the front side of the base portion 101 in a substantially orthogonal direction. In other words, the support rail portion 110 is coupled to the base portion 101 at approximately a 90-degree angle. As would be appreciated by one having skill in the art with the aid of the present disclosure, the support rail portion 110 may deviate somewhat from a 90-degree angle in alternative embodiments. In the operational configuration, a portion of the support rail portion 110 may extend above the top surface of the mattress or other piece of furniture.

The support rail portion 110 of the detachable bed rail 100 comprises a structure for providing support for an individual during ingress to and egress from the bed or similar furniture. For example, once the base portion 101 is coupled to the bed as described above, the user may grip the support rail portion 110 and lower himself or herself onto the bed. The user may also maintain contact with the support rail portion 110 in order to position himself or herself on the bed. Likewise, if the user desires to get out of the bed, the user may grip the support rail portion 110 to swing his or her legs off the bed. Once in this position, the user may pull on the support rail portion 110 in order to rise into a standing position. While the user moves to a standing position, the support rail portion 110 assists in establishing the user's balance. The support rail portion 110 may also function as an arm rest for the user while the user is sitting on the bed.

The structure of the support rail portion 110 may include a plurality of exterior rails defining a length and height of the support rail portion 110. The exterior rails may comprise horizontal and vertical rails. The exterior rails may be rigidly coupled to each other at or adjacent their end portions. In some embodiments, one or more couplings of exterior rails may comprise a continuous bar defining a smooth radiused corner between the horizontal and vertical rails. In the current embodiment, a bottom horizontal rail comprises two rail segments extending inward from exterior vertical rails and define a space between the inward ends of the two rail segments. Moreover, as would be appreciated by one having skill in the art with the aid of the present disclosure, the exterior rails may comprise rail portions which deviate from the horizontal and vertical orientations.

The cross section of the exterior rails may be sized and shaped for comfortable and ergonomic gripping of the exterior rails by the user. The exterior rails may also be sized and shaped to facilitate user comfort when used as an arm rest. In such instances, larger diameters may provide enhanced comfort over smaller diameters. In some embodiments, the diameter of the exterior rails may be between 28 and 32 mm. In other embodiments, the diameter of the exterior rails may be between 20 and 60 mm, 25 and 50 mm, 29 and 40 mm or greater than 26 or 28 mm. Enhanced comfort may also be provided by a relatively large corner radius when a top horizontal exterior rail is coupled to an exterior vertical rail. In some embodiments, the outside radius of curvature defining a curved coupling between a top horizontal exterior rail and an exterior vertical rail may be between 130 and 140 mm. In other embodiments, the outside radius of curvature may be between 70 and 150 mm or 100 and 140 mm or greater than 130 mm. The diameter of an exterior rail, defining a radius of curvature in a first direction, and the bend radius of the coupling between a top horizontal exterior rail and a vertical exterior rail, defining a radius of curvature in a second direction, may combine to define a compound curved surface configured to provide comfort to the user. The length L100 of the support rail portion 110 may be between 680 and 700 mm. In other embodiments, length L100 of the support rail portion 110 may be between 300 and 800 mm, 500 and 800 mm, 600 and 700 mm, or 650 and 700 mm.

The support rail portion 110 may comprise a plurality of internal rails sufficient to provide a structure to the exterior rails capable to withstand the applied forces during use. The support rail portion 110 may comprise internal horizontal and vertical rails coupled to the exterior rails. One or more of the plurality of internal rails may be coupled to each other. In the current embodiment, the support rail portion 110 comprises two internal horizontal rails and one internal vertical rail. In other embodiments, the support rail portion 110 may comprise fewer or more internal rails, and the rails may be disposed in orientations other than horizontal and vertical. The internal rails may be sized and shaped for comfortable and ergonomic gripping by the user.

The distance between rails may be selected such that a portion of an individual's body, such as a user's head, would be unable to fit between two adjacent rails. Consequently, the support rail portion 110 also may function to prevent users from falling out of bed.

As depicted in FIG. 1, the detachable bed rail 100 may comprise a coupling system 130 configured to rigidly couple the support rail portion 110 to the base portion 101 in the operational configuration. The coupling system 130 may comprise coupling members fixedly attached to the base portion 101 and the support rail portion 110. The coupling system 130 may provide for decoupling of the support rail portion 110 from the base portion 101 by the user.

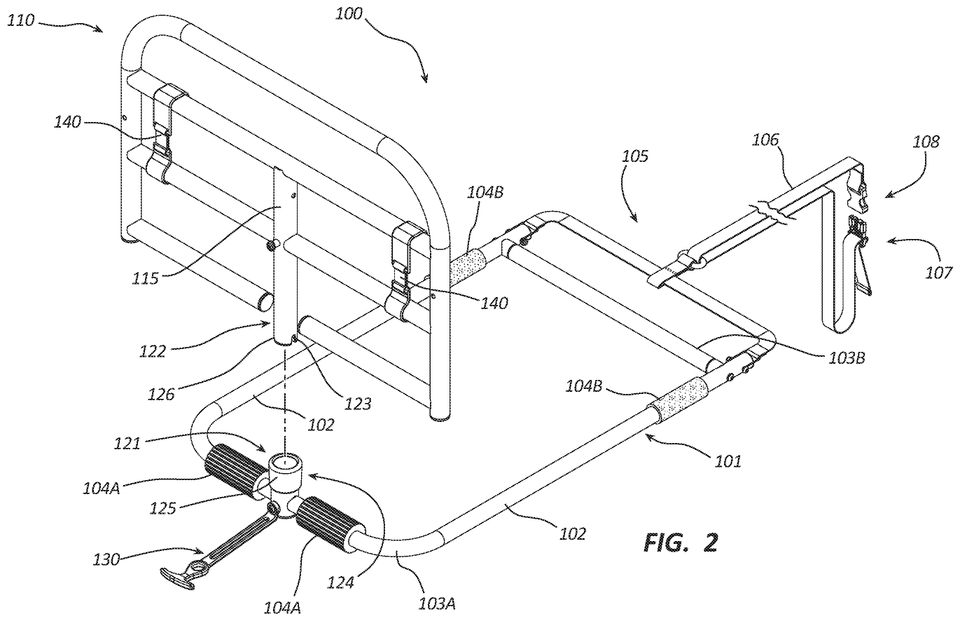

Referring to FIG. 2 and as described above, the base portion 101 may include one or more base coupling members. In the current embodiment, a single base coupling member 121 is attached to the base portion 101 and more specifically to the front crossbar 103A. In other embodiments, the base coupling member 121 may be coupled to the other crossbar 103B and/or one or both of the base legs 102. In the current embodiment, the base coupling member 121 is centered between the base legs 102. In other embodiments, the base coupling member 121 may be offset from the center location. In the current embodiment, the base coupling member 121 extends vertically upward from the base portion 101. In other embodiments, the base coupling member 121 may extend downward or toward the front, right or left sides of the base portion 101. In the current embodiment, the base coupling member 121 is disposed adjacent the side of the mattress. In the other embodiments, the base coupling member 121 may be disposed away from or partially under the mattress.

The support rail portion 110 may comprise a support coupling member 122 complementary to the base coupling member 121 as stated above. The support coupling member 122 may be rigidly attached to one or more of the horizontal and vertical rails of the support rail portion 110. In the current embodiment, the support coupling member 122 comprises a downward extension of a center vertical rail 115. In other embodiments, the support coupling member 122 may be an extension of another vertical rail or coupled to a vertical rail. Still in other embodiments, the support coupling member 122 may be coupled to one or more horizontal exterior or interior rails. As would be apparent to one having skill in the art, the center vertical rail 115 may comprise dimensions different from the other rail members so as to provide for the strength to support the support rail portion 110 under load.

In further reference to FIG. 2, the detachable bed rail 100 comprises a single point of coupling engagement between the support rail portion 110 and the base portion 101 comprising a single pair of complementary coupling members. As would be apparent to those having skill in the art, the single point of engagement may be configured to inhibit translational displacement in any direction and rotational displacement about any axis of the support rail portion 110 relative the base portion 101. According to the current embodiment, the support rail coupling member 122 is configured as a post 126 extending vertically downward, and the base coupling member 121 is configured as a post receiver 125. The post receiver 125 comprises a vertically oriented cylinder having an open top end and an internal diameter configured to slidably receive the post 126. The post 126 and post receiver 125 may have a common longitudinal axis when engaged.

The post 126 and the post receiver 125 may be complementarily sized to provide a rigid coupling between the support rail portion 110 and the base portion 101. In other words, the clearance between the post 126 and the post receiver 125 may be such that sliding engagement is provided, while the clearance and length of the engagement may be sized to minimize tipping of the support rail portion 110 relative to the base portion 101 when engaged. In the current embodiment, the post 126 and post receiver 125 may respectively comprise external and internal cylindrical shapes of constant diameter. In other embodiments, the post 126 and post receiver 125 may comprise tapered portions along at least a portion of the engagement length. In such embodiments, the tapered portions may provide for ease of initial engagement, and in other embodiments, the tapered portions may provide for enhanced coupling rigidity. In other embodiments, the base portion 101 may comprise the post 126, and the support rail portion 110 may comprise the post receiver 125.

Still referring the FIG. 2, the post 126 and post receiver 125 may also comprise complementary features configured to prevent relative rotation about the common longitudinal axis. In the current embodiment, the post 126 comprises at least one slot 123 in the cylindrical wall configured to engage at least one inner protrusion 124 (hidden within the post receiver in FIG. 2) disposed on an inside wall of the post receiver 125 to establish a fixed rotational orientation between the base portion 101 and the support rail portion 110. As would be apparent to those having skill in the art and the benefit of this disclosure, other complementary coupling features may provide for fixed rotational orientation. For example, some embodiments may comprise a key way, a spline, a non-cylindrical shaped post, etc. Furthermore, the post 126 may comprise an outer protrusion configured to engage a slot in the cylinder wall of the post receiver 125.

The single point of engagement centrally located on the support rail portion 110 may provide a benefit for the user. The central location of the single point of engagement may define a vertical axis of symmetry when the support rail portion 110 is disposed in the operational configuration. In the current embodiment, the post 126 is disposed centrally on the bottom of the support rail portion 110. As such, a user holding the support rail portion 110 by grasping the horizontal portion of the top rail at a central location may result in the post 126 extending vertically downward. In other words, the support rail portion 110 may be held by a single hand of the user, resulting in an orientation of the post 126 consistent with engagement of the post receiver 125. Engagement may then be facilitated by disposing the post 126 above the post receiver 125 and vertically lowering the support rail portion 110 to engage the post 126 with the post receiver 125.

The current embodiment may provide an additional benefit for the user during engagement by separating the engagement process into two steps. The cylindrical complementary shapes of the post 126 and post receiver 125 provide for at least partial engagement without requiring an initial rotational alignment of the post 126 and post receiver 125 along the common longitudinal axis. In other words, the user may partially engage the post 126 and post receiver 125 when the support rail portion 110 and the base portion 101 are rotationally misaligned. In this partial engagement state, tipping of the support rail portion 110 may be inhibited and, hence, the user may ungrasp the support rail portion 110. Completion of the engagement process may then be facilitated by rotation of the support rail portion 110 about the common longitudinal axis to align the inner protrusion 124 with the slot 123, allowing gravity to displace the support rail portion 110 downward into full engagement.

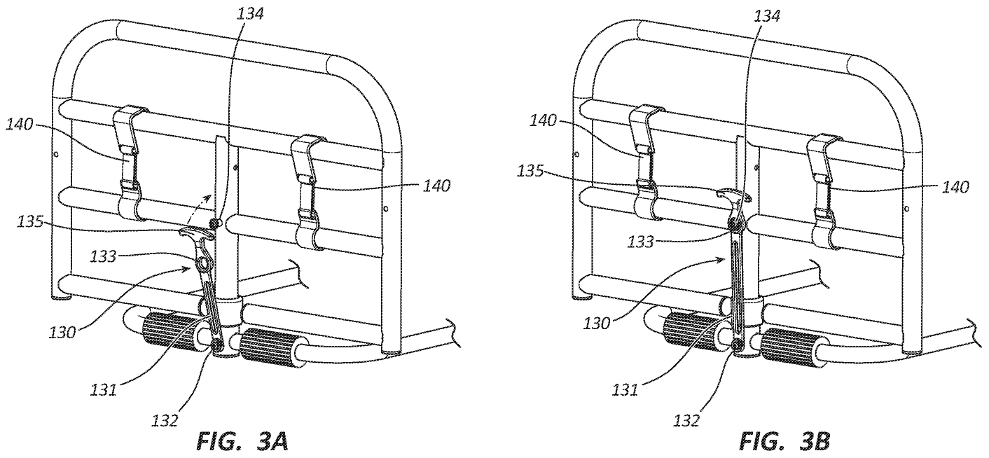

Referring now to FIGS. 3A-B, the detachable bed rail 100 may include a securing mechanism 130, so as to prevent disengagement of the support rail portion 110 from the base portion 101 in the operational configuration. In other words, the securing mechanism 130 may secure engagement of the post 126 and the post receiver 125. FIG. 3A depicts the securing mechanism 130 in an unsecured state and FIG. 3B depicts the securing mechanism 130 in a secured state.

The securing mechanism 130 may comprise a flexible or stretchable strap 131, such as an elastomeric strap. The stretchable strap 131 may be coupled to the base portion 101 at a first end of the stretchable strap 131 and coupled to the support rail portion 110 at an opposite second end. The stretchable strap 131 may be configured to be in tension when coupled at each end. The second end of the strap 131 may be configured to be coupled to and decoupled from the support rail portion 110 by the user, by displacement of the second end of the strap 131 relative to the first end of the strap 131. In other embodiments, the user may decouple the first end of the strap 131 from the base portion 101. In the current embodiment, support rail portion 110 may comprise a protrusion 134 disposed on a side wall of the vertical rail member 115, and the stretchable strap 131 may comprise a complementary orifice 133 disposed at the second end configured to engage the protrusion 134 such that, when engaged, tension in the strap 131 is maintained and the support rail portion 110 is secured to the base portion 101. The protrusion 134 may be configured such that disengagement of the orifice 133 from the protrusion 134 is prevented without an increase in tension of the strap 131. The second end of the strap 131 may be decoupled from the support rail portion 110 by manually increasing the tension in the strap 131 and disengaging the orifice 133 from the protrusion 134.

The strap 131 may comprise a handle 135 at the second end configured to be gripped by a user. The handle 135 may be T-shaped so as to facilitate applying tension to the strap 131 by a user using two or more fingers of one hand. The strap 131 may be configured so that the operating tension in the strap 131 may be applied without the manual application of an oppositely applied force to the detachable bed rail 100. In other words, the weight and/or attachment of the mobility device to the bed may be sufficient to oppose the tension in the strap 131 when a tension force is applied by the user to the handle 135. As such, the user may enable and disable the securing mechanism 130 with a single hand. As would be apparent to those having skill in the art and the benefit of this disclosure, other shapes of handles or gripping features of the second end of the strap 131 may be contemplated as suitable for manually applying tension to the strap 131, and as such are included in this disclosure.

The strap 131 may be formed of an elastomeric or rubber material. Alternatively, the strap 131 may comprise a combination of non-stretchable and stretchable portions. As may be appreciated by one of ordinary skill, any longitudinal member having a variable length dimension corresponding to a force applied between end portions may facilitate the disclosed function of the strap 131, and as such is included in this disclosure. As also would be apparent to those having skill in the art with the aid of the present disclosure, alternative securing mechanisms may facilitate detachable coupling of the support rail portion 110 to the base portion 101. Exemplary alternative mechanisms may include detent mechanisms, spring loaded pins with corresponding orifices, latches, etc., and as such are included in this disclosure.

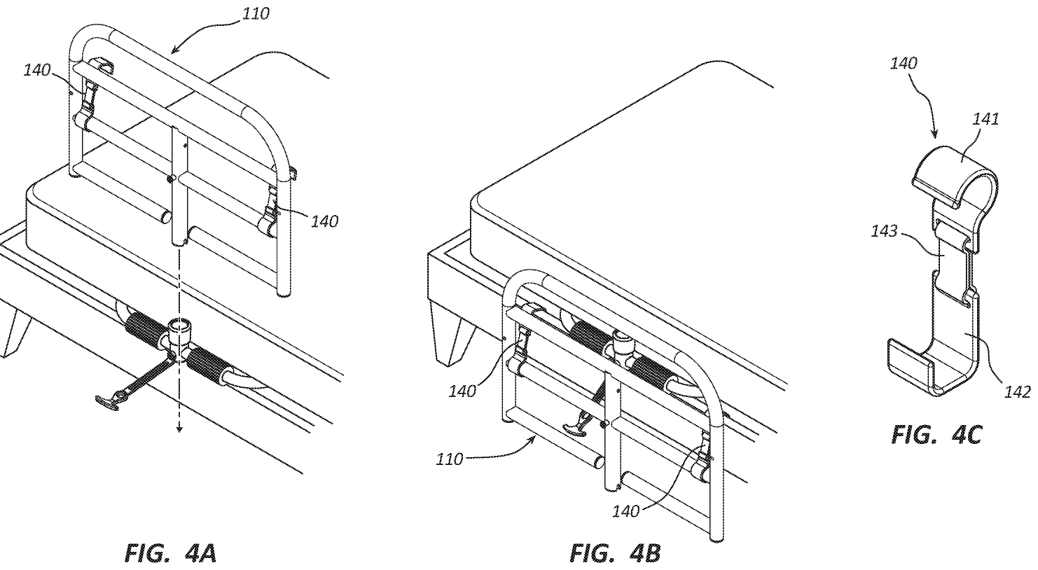

Referring to FIGS. 4A-B, the support rail portion 110 may be decoupled from the base portion 101 and disposed in a second or storage configuration. FIG. 4A depicts the support rail portion 110 disengaged from the base portion 101. In other words, FIG. 4A shows the post 126 separated from the post receiver 125. FIG. 4B depicts the support rail portion 110 in the storage configuration. The storage configuration may comprise coupling of the support rail portion 110 directly to the bed or a portion thereof, such as the bed frame. In the storage configuration, the support rail portion 110 may be disposed in a vertical orientation along a side of a bed but disposed below the top surface of the mattress. In other words, in the storage configuration, the support rail portion 110 may be disposed in the same relative orientation as when disposed in the operational configuration. The coupling to the bed may comprise a structure utilizing the weight of the support rail portion 110 to facilitate engagement of the support rail portion 110 to the bed. In this position, the user may enter or exit the bed or furniture without obstruction from the support rail portion 110.

Referring to FIGS. 4A-4C, the detachable bed rail 100 may comprise a pair of bed engagement members 140. The bed engagement members 140 may be configured to couple the support rail portion 110 to the bed when the support rail portion 110 is decoupled from the base portion 101. In the current embodiment, the pair of bed engagement members 140 may be similar to each other and interchangeable in use. In other embodiments, the pair of bed engagement members 140 may be different in dimensions and functionality and thus may not be interchangeable.

Each bed engagement member 140 may comprise an elongate portion having a rail engagement portion 141 at one end and a bed engagement portion 142 at an opposite end. The rail engagement portion 141 and the bed engagement portion 142 may be configured such that upon decoupling from the bed, the bed engagement member 140 remains coupled to the support rail portion 110. Alternatively, the rail engagement member 141 and the bed engagement member 142 may be configured such that upon decoupling from the bed, the bed engagement member 140 remains coupled to the bed.

The rail engagement portion 141 may be configured to wrap around or otherwise engage at least a portion of a rail of the support rail portion 110. The rail engagement portion 141 may comprise a semi-rigid portion configured to flex and snap around a portion of a rail of the support rail portion 110. In some embodiments, the rail engagement portion 141, when coupled, may freely rotate around the engaged rail. In other embodiments, rotation of the rail engagement portion 141 around the engaged rail may be inhibited or restricted.

The bed engagement portion 142 may be configured to engage a bed frame. More specifically, the bed engagement portion 142 may comprise a hook configured to engage a top edge of the bed frame. In some embodiments, the bed engagement portion 142 may also be configured to engage the base portion 101. In other words, the support rail portion 110 may be coupled to the base portion 101 in the storage configuration. In other embodiments, the bed engagement portion 142 may be configured to fixedly couple to the bed frame.

The bed engagement members 140 may comprise a flexible elongate portion 143 between the rail and bed engagement portions 141, 142. The length of the flexible elongate portion 143 may be fixed or adjustable. The flexible elongate portion 143 may facilitate manual displacement of the support rail portion 110 away from the side of the bed while the support rail portion 110 remains coupled to the bed. Such displacement may allow the user to have space to access the side of bed behind the support rail portion 110 to facilitate manipulation of the sheets, blankets, etc., without decoupling the support rail portion 110 from the bed.

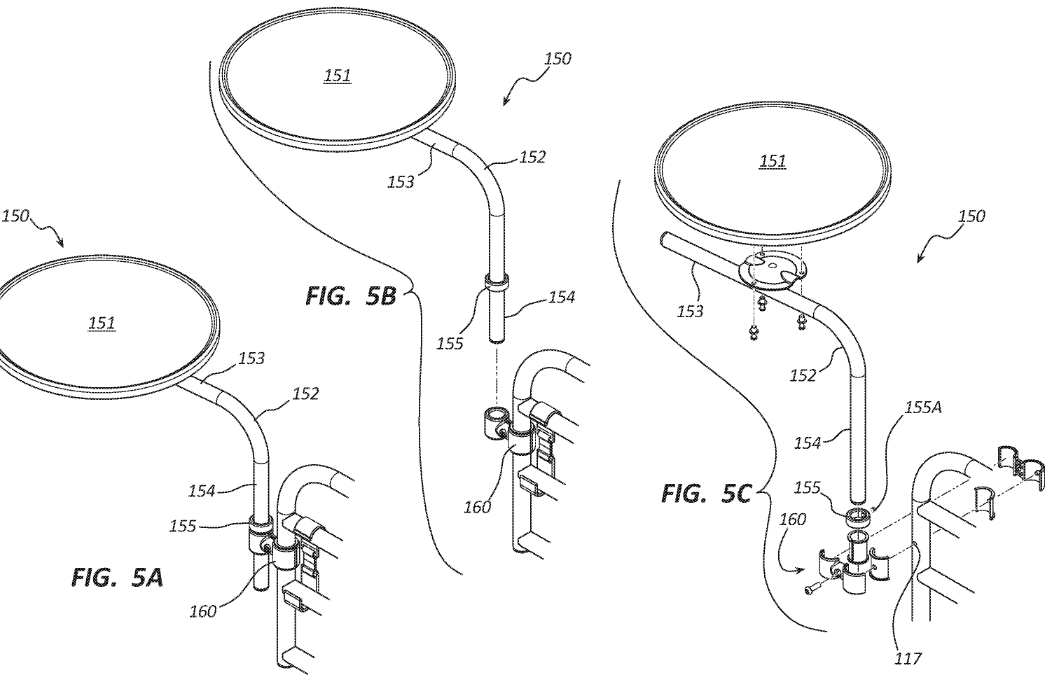

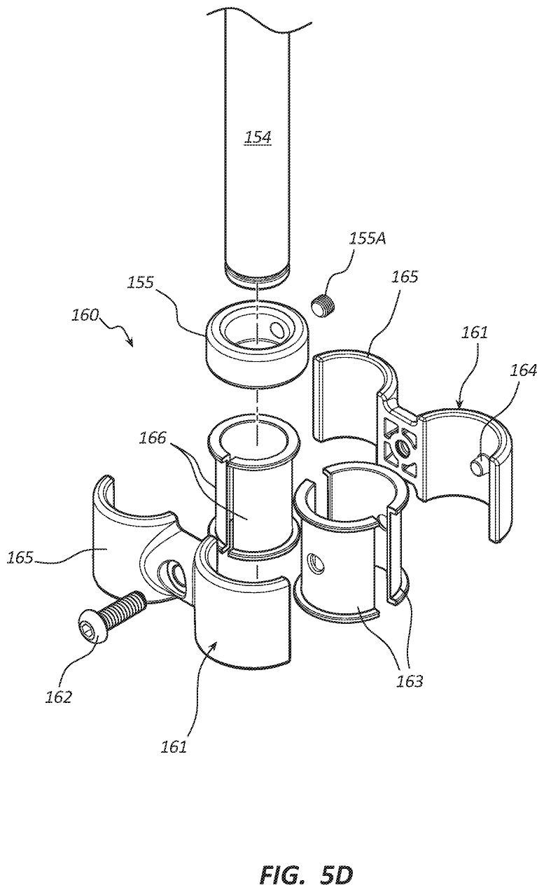

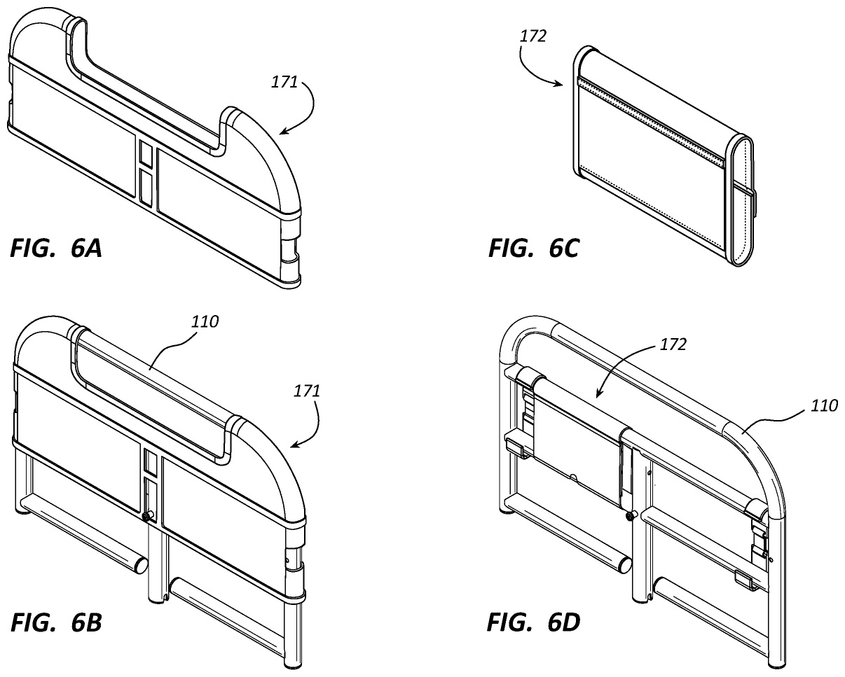

The detachable bed rail 100 may comprise optional accessories to enhance or add functionality to the detachable bed rail 100 as depicted in FIGS. 5A-D, 6A-D, and 7. The optional accessories may comprise a tray table 150, rail covers 171, 172, and a rail extension 190. The detachable bed rail 100 may facilitate attachment and use of each accessory individually or in combination with any or all other accessories.

Referring to FIGS. 5A-C, the tray table 150 may be configured for placement of food items, beverage containers, etc. thereon. FIG. 5A depicts the tray table 150 coupled to the support rail portion 110 via attachment clamp 160. The tray table 150 may comprise a horizontal surface 151 and a rail member 152. The rail member 152 may comprise a horizontal rail section 153 and a vertical rail section 154. The horizontal surface 151 may be coupled to the horizontal rail section 153 of the rail member 152. In some embodiments, the horizontal surface 151 may be coupled at more than one location along the length of the horizontal rail section 153.

As depicted in FIG. 5B, the vertical rail section 154 may be slidably coupled to the attachment clamp 160 such that the tray table 150 may be decoupled from the support rail portion 110 by sliding the vertical rail section 154 upward through and free from the attachment clamp 160. In some embodiments, the engagement of the vertical rail section 154 with the attachment clamp 160 may comprise minimal friction. In other embodiments, the engagement of the vertical rail section 154 with the attachment clamp 160 may comprise friction to inhibit sliding and/or rotational displacement of the vertical rail section 154 relative to the attachment clamp 160. Such friction may provide for a stable position of the tray table 150 in the absence of a force applied by the user with intent to displace the tray table 150.

The tray table 150 may comprise a collar 155 attached to the vertical rail section 154. The collar 155 may be configured to prevent downward displacement of the vertical rail section 154 relative to the attachment clamp 160 beyond a limit. In other words, the collar 155 may abut the attachment clamp 160 establishing a fixed height for the horizontal surface 151. The collar 155 may comprise a threaded fastener 155A to facilitate securing the collar 155 to the vertical rail section 154. As such, the collar 155 may be unsecured from the vertical rail section 154, disposed at different position along the length of the vertical rail section 154, and re-secured so as to establish a different height for the horizontal surface 151. In some instances, the collar 155 may be omitted.

The attachment clamp 160 may facilitate coupling of the tray table 150 to the support rail portion 110. In the current embodiment, the attachment clamp 160 may facilitate coupling of the tray table 150 to any vertical rail member of the support rail portion 110. As such, the tray table 150 may be positioned at different locations along the length of the support rail portion 110. In other words, in the current embodiment, the tray table 150 may be coupled to either of the exterior vertical rails or the interior vertical rail 115.

Referring to FIG. 5D, the attachment clamp 160 may comprise a first set of opposing curved portions 161 configured to engage a vertical rail of the support rail portion 110 and a threaded fastener 162. In the current embodiment, the threaded fastener 162 is configured to establish a clamping force between the first set of opposing curved portions 161 and a vertical rail. In some instances, a vertical rail may comprise different diameters. To account for the different diameters, and more specifically a smaller diameter, the attachment clamp 160 may comprise a pair of sleeves 163 configured to be disposed between the first set of opposing curved portions 161.

The attachment clamp 160 may also comprise a protrusion 164 disposed on an inner surface of at least one curved portion, configured to engage a receiving hole 117 (shown in FIG. 5C) in a side wall of a vertical rail. Engagement of the protrusion 164 with a receiving hole 117 may define a specific location and orientation of the attachment clamp 160 relative to the vertical rail. The vertical rails may comprise one or more receiving holes 117 disposed at defined locations so as to establish one or more defined locations and orientations of the attachment clamp 160. Engagement of the protrusion 164 and a receiving hole 117 may provide for secure engagement with the vertical rail with a lower clamping force than otherwise may be required.

The attachment clamp 160 may comprise a second set of opposing curved portions 165 configured to engage the vertical rail section 154 of the tray table 150. In the current embodiment, the attachment clamp 160 comprises a split bushing 166 configured to be disposed between the second set of curved portions 165 and the vertical rail section 154. The split bushing 166 may be configured to provide for rotational and longitudinal sliding displacement of the vertical rail section 154 vertical portion relative to the attachment clamp 160. The bushing 166 may be omitted to provide for coupling of the attachment clamp 160 to a vertical rail having a larger diameter, as is discussed below.

When the tray table 150 is coupled to the support rail portion 110, the tray table 150 may be rotated about the axis of the vertical rail section 154. The rotational displacement combined with a radial distance of the horizontal surface 151 from the longitudinal axis of the vertical rail section 154 results in a lateral positioning of the horizontal surface 151 along a circumferential path. In other words, the horizontal surface 151 may be disposed toward or away from the user by swiveling the tray table 150 about the axis of the vertical rail section 154.

The vertical position of the horizontal surface 151 may also be adjusted by vertically displacing the vertical rail section 154 through the bushing 166. In other words, the tray table 150 may be raised and lowered by sliding the vertical rail section 154 through the bushing 166. In some instances, the tray table 150 may be separated from the detachable bed rail 100 by sliding the vertical rail section 154 upward through the bushing 166 until the vertical rail section 154 is completely removed from the bushing 166.

In the current embodiment, the threaded fastener 162 is also configured to establish a clamping force between the second set of opposing curved portions 165 and the vertical rail section 154 of the tray table. The threaded fastener 162 may provide for an adjustable clamping force. As the attachment clamp 160 is configured to provide for rotational and longitudinal sliding displacement of the vertical rail section 154, the adjustable clamping force may provide for an adjustable range of friction between the attachment clamp 160 and vertical rail section 154. The adjustable range of friction may result in an adjustable level of positional stability of the horizontal surface 151. In other words, tightening and loosening the threaded fastener 162 may directly correlate to the amount of force the user must apply to the tray table 150 to change its position. More specifically, the user may tighten the threaded fastener 162 to increase the force required to reposition the tray table 150.

FIGS. 6A-D illustrate first and second optional rail covers 171, 172. The first and second optional rail covers 171, 172 may comprise similar features and functionalities. Each rail cover 171, 172 may be configured to cover a portion of the support rail portion 110. In some instances the rail covers 171, 172 may provide a more comfortable rail contact surface for the user. For example, the rail covers 171, 172 may comprise cushioning portions to add comfort to the user and/or prevent discomfort, such as in an instance of impact between a body part and the support rail portion 110. The rail covers 171, 172 may be formed of any flexible sheet material, such as a woven fabric, vinyl, plastic, rubber, leather, etc. The rail covers 171, 172 may comprise holes, voids or openings at defined locations to facilitate defined functionality. For example, the rail covers 171, 172 may comprise openings to facilitate attachment of accessories to the support rail portion 110. The rail covers 171, 172 may function as a physical barrier. For example, the rail covers 171, 172 may prevent disposition of hands, heads or other body parts through one or more openings between adjacent rails in the support rail portion 110.

The rail covers 171, 172 may comprise one or more pouches. The one or more pouches may be configured to receive and contain physical items, such as rings, books, wallets, watches, phones, remote controls, etc. In some instances, the one or more pouches may be expandable to accommodate larger items such as beverage containers. The one or more pouches may be disposed on the front or back side of the support rail portion 110.

The rail cover 171 may be configured to slip over a top portion of the support rail portion 110. As such, the rail cover 171 may cover an upper portion of the support rail portion 110 including the upper portions of the exterior rails. The rail cover 171 may comprise shapes such as radiused corners to align with the corners of support rail portion 110. The rail cover 171 may be sized so as to provide a tight fit over the support rail portion 110. In some embodiments, the material forming the rail cover 171 may be stretchable and under tension when disposed over the support rail portion 110. In some instances, the rail cover 171 may cover all or substantially all of the support rail portion 110 extending above the mattress. The rail cover 171 may comprise openings to facilitate direct grasping by the user of one or more rails of the support rail portion 110. More specifically, the rail cover 171 may comprise openings at the upper corners of the support rail portion 110. In some embodiments, the rail cover 171 may comprise coupling fasteners, such as hook and loop portions, snaps, buttons, etc., to facilitate securement of the rail cover 171 to the support rail portion 110.

The rail cover 172 may couple to one or more interior rails of the support rail portion 110. As such, the rail cover 172 may comprise fasteners such as hook and loop portions, snaps, buttons, laces, etc., to facilitate coupling between the rail cover 172 and one or more rails of the support rail portion 110, and/or coupling between a first portion and a second portion of the rail cover 172. The rail cover 172 may be fastened to the support rail portion 110 under tension. In some embodiments, the fasteners may be configured to establish tension in the rail cover 172. In some embodiments, the material forming the rail cover 172 may be stretchable.

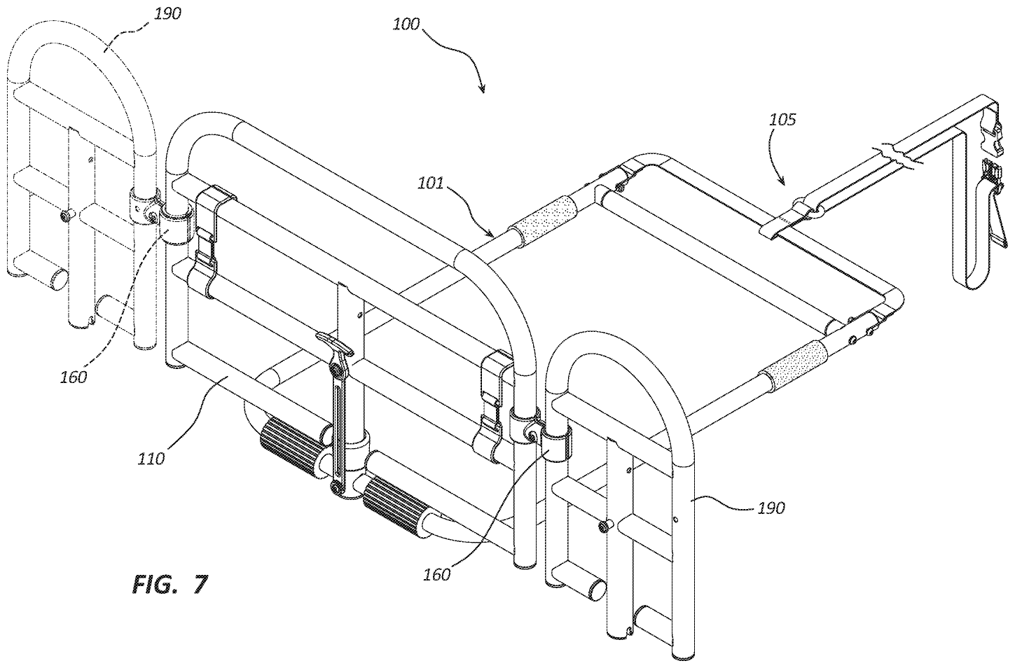

FIG. 7 depicts an optional extension 190 attached to the detachable bed rail 100 so as to extend the effective length of the support rail portion 110. In some embodiments, the extension 190 may resemble a shorter version of the support rail portion 110. In further embodiments, the extension 190 may comprise many similar features of the support rail portion 110, including but not limited to exterior and interior rails, engagement holes for coupling to the attachment clamp 160, smooth radiused corners, etc. The extension 190 may also be configured to receive a rail cover 172 and to couple to the tray table 150.

The extension 190 may be coupled to the support rail portion 110 via the attachment clamp 160. In such instances, the bushing 166 may be omitted from the attachment clamp 160. The support rail portion 110 and the extension 190 may be configured for attachment of the extension 190 to both the right and left sides of the support rail portion 110. In some instances, more than one extension 190 may be attached to the support rail portion 110. In some embodiments, the extension 190 may comprise one or more bed engagement members 140 so as to facilitate attachment of the extension 190 to the bed in a storage configuration. In some instances, the support rail portion 110 may comprise an attached extension 190 when disposed in the storage configuration. In some instances, one of the bed engagement members 140 may couple the support rail portion 110 to the bed frame, and the other of the bed engagement members 140 may couple the extension 190 to the bed frame.

With reference to FIGS. 1-7, use of the detachable bed rail 100 may comprise one or more of the following operational steps. The user may couple the detachable bed rail 100 to a bed. In so doing, the user may place the base portion 101 between the mattress and a box spring of the bed. The user may position the base portion 101 along the side of the bed so as to provide the desired functionality. The user may extend the attachment member 105 to an opposite side of the bed and secure the anchoring member 107 to the bed frame. The user may adjust the length of the strap 106 so that the base coupling member 121 is adjacent the side of the mattress. The user may dispose the support rail portion 110 in the first or operational configuration by attaching the support rail portion 110 to the base portion 101. The user may insert the post 126 into the post receiver 125 and adjust the rotational position of the support rail portion 110 until the slot 123 engages the inner protrusion 124 securing the rotational position. The user may grip the handle 135 and pull upward on the securement strap 131 to engage the orifice 133 with the protrusion 134. The user may attach a tray table 150 to the support rail portion 110 and position the horizontal surface 151 to a desirable vertical position and secure the collar 155. The user may swivel the tray table 150 about the vertical rail section 154 to establish a desired lateral position for use, and the user may also swivel the tray table 150 about the vertical rail section 154 to establish a desired lateral position for non-use. The user may attach one of the rail covers 171, 172 to the support rail portion 110. The user may attach one or more extensions 190 to the support rail portion 110. The user may grip the handle 135 and pull upward on the securement strap 131 to disengage the orifice 133 from the protrusion 134. The user may separate the support rail portion 110 from the base portion 101 by sliding the post 126 free from the post receiver 125. The user may dispose the support rail portion 110 in the second or storage configuration and couple the support rail portion 110 to the bed frame. The user may couple the support rail portion 110 to the bed frame by engaging the bed engagement members 142 with the bed frame.

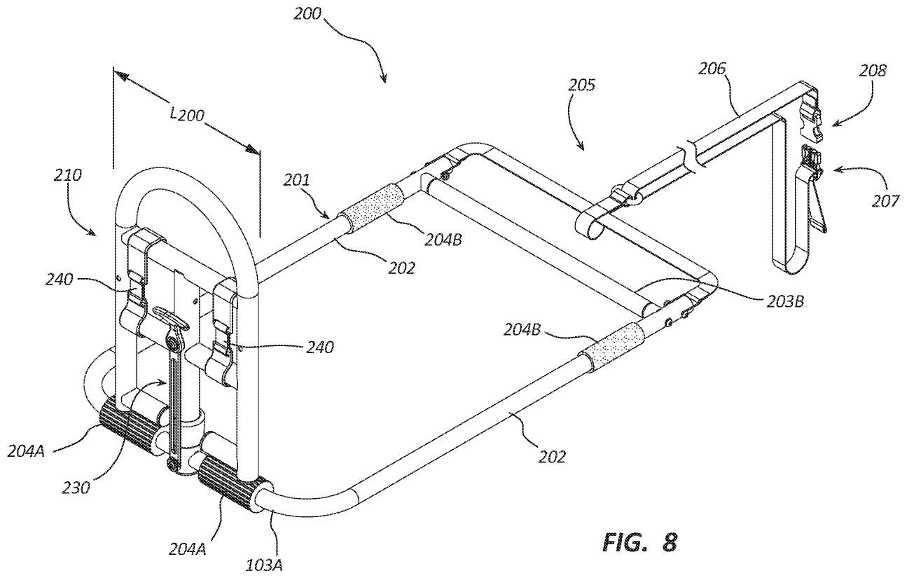

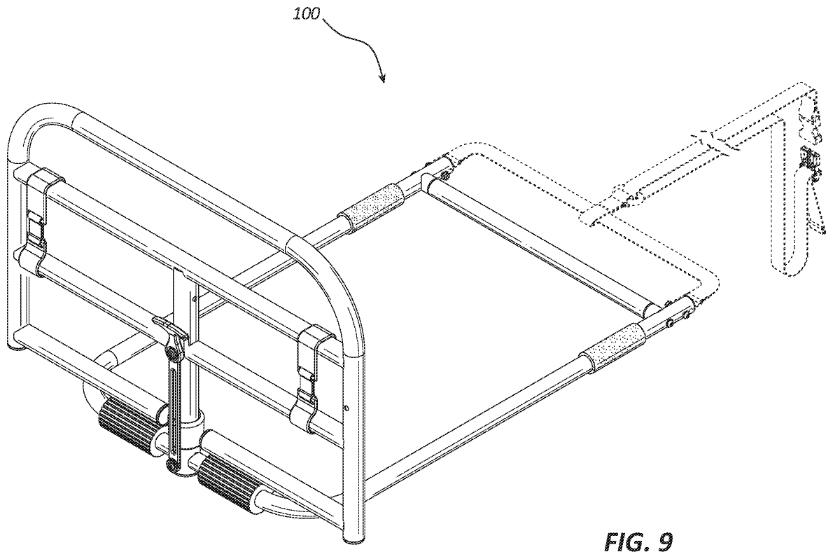

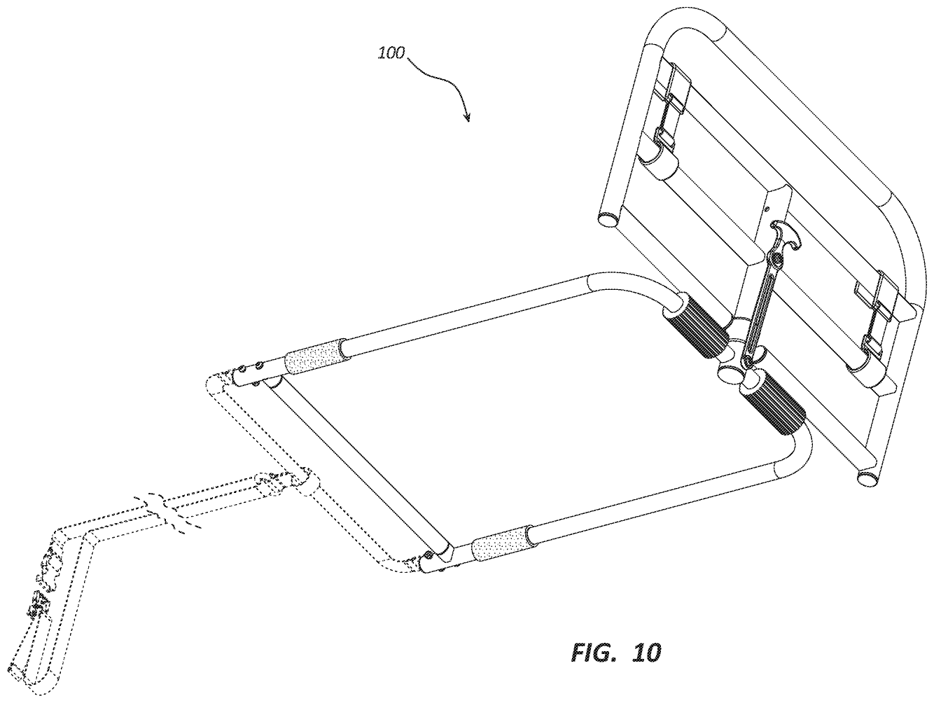

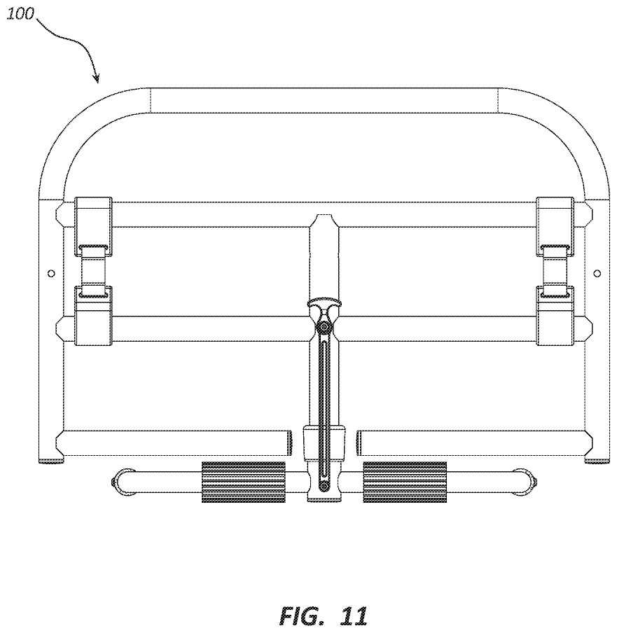

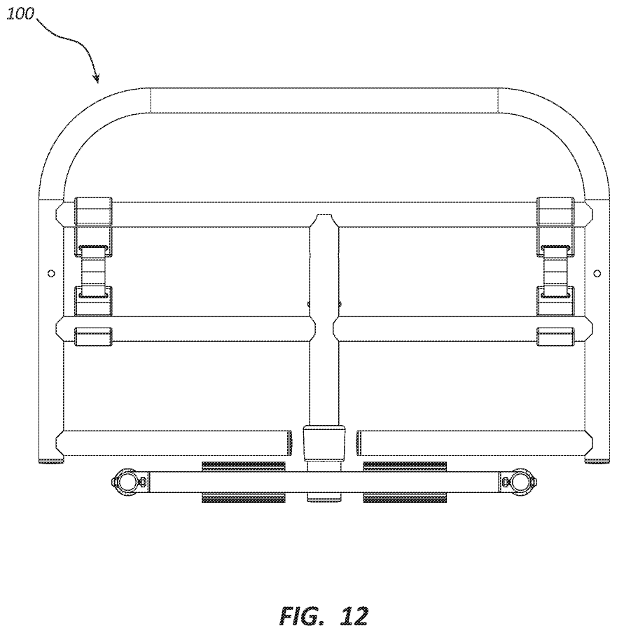

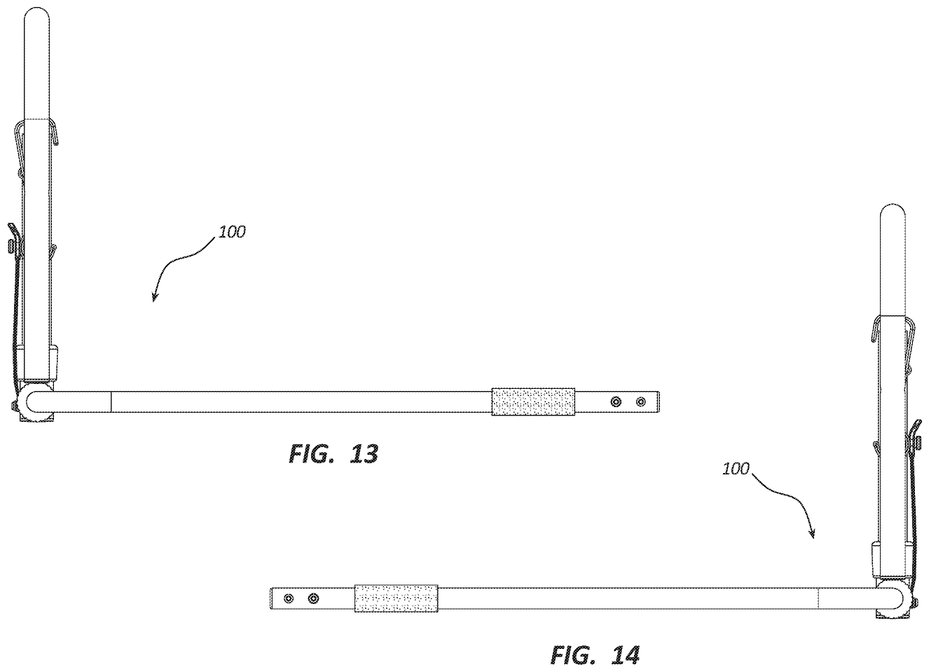

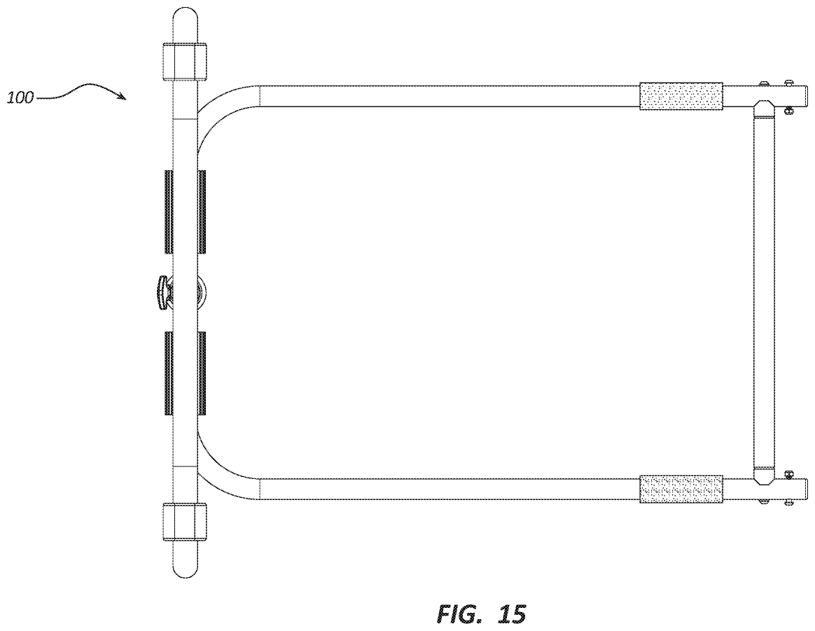

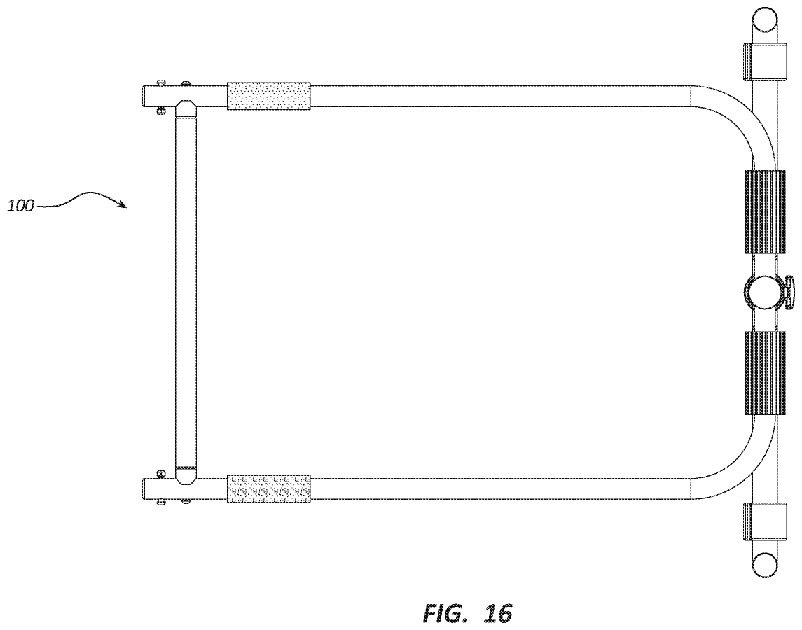

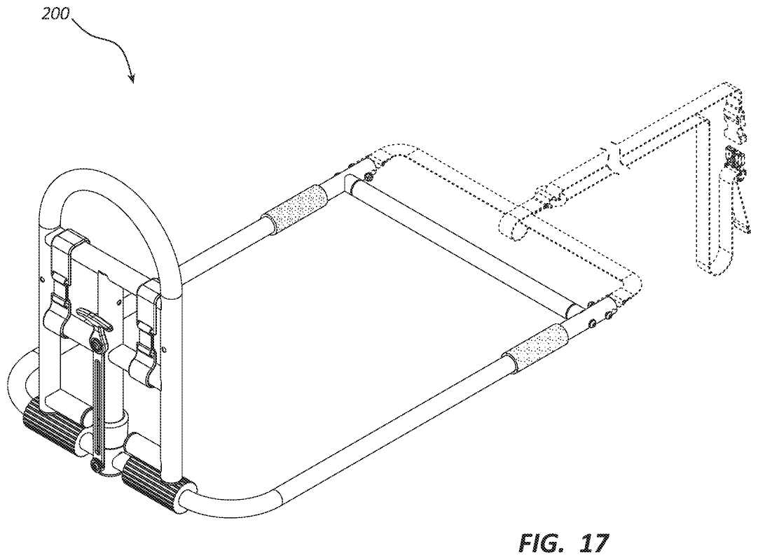

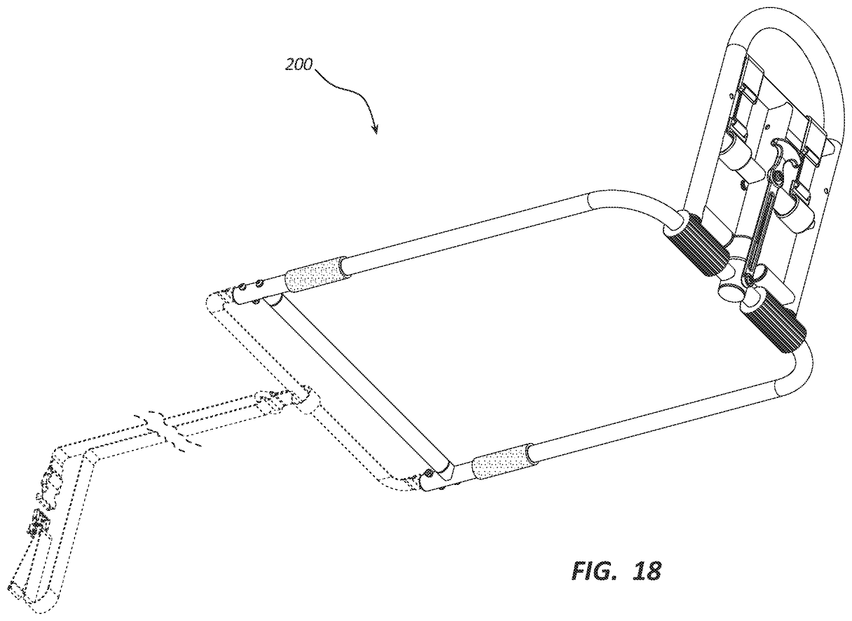

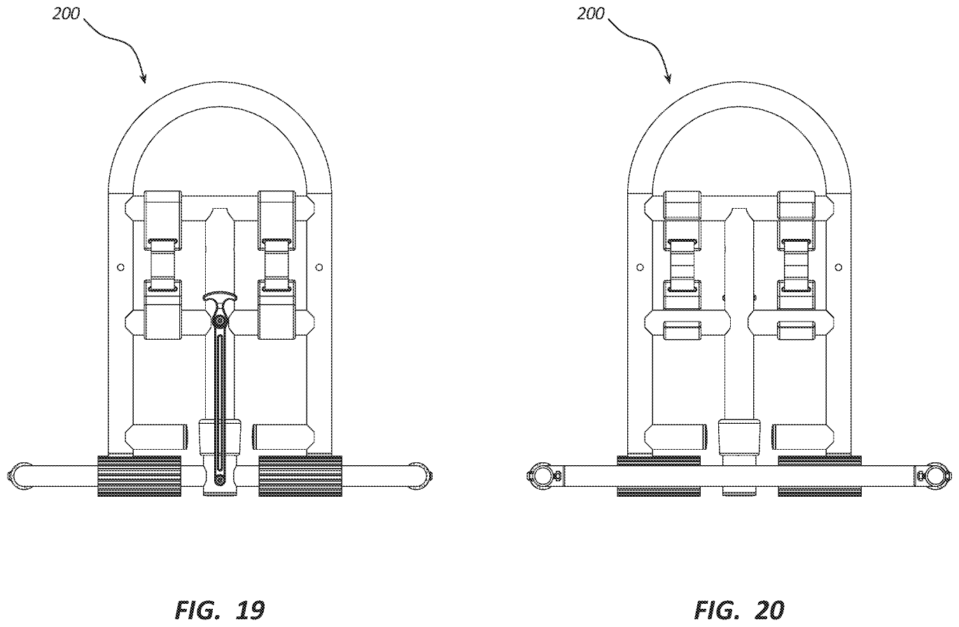

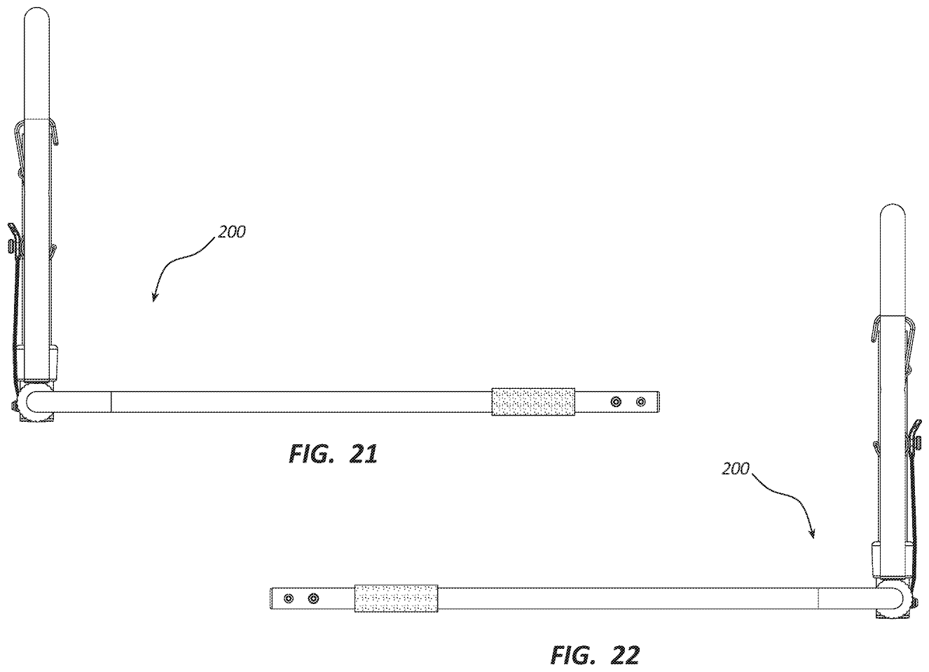

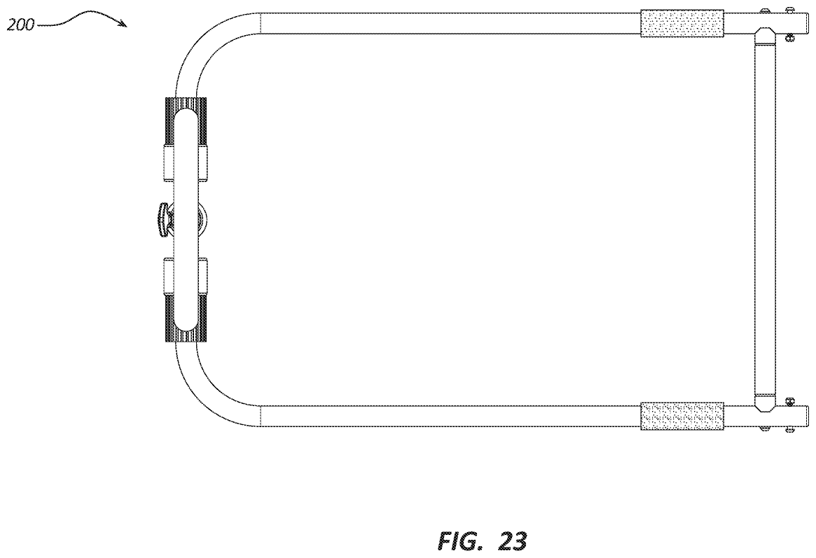

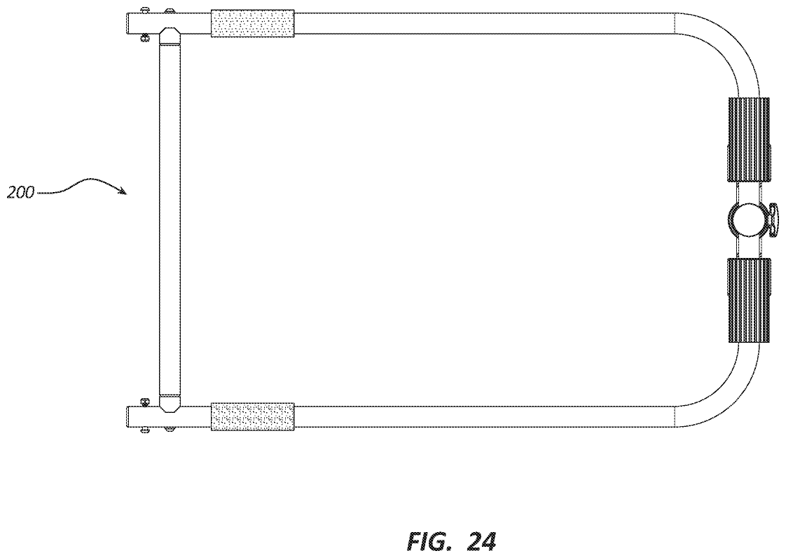

FIG. 8 depicts a second embodiment of a detachable bed rail 200 that resembles the detachable bed rail 100 described above in certain respects. Accordingly, like features are designated with like reference numerals, with the leading digits incremented to “2.” For example, the embodiment depicted in FIG. 8 includes a base portion 201 that may, in some respects, resemble the base portion 101 of FIGS. 1 and 2. Relevant disclosure set forth above regarding similarly identified features thus may not be repeated hereafter. Moreover, specific features of the detachable bed rail 100 and related components and accessories shown in FIGS. 1-7 may not be shown or identified by a reference numeral in FIG. 8 or specifically discussed in the written description that follows. However, such features may clearly be the same, or substantially the same, as features depicted in other embodiments and/or described with respect to such embodiments. Accordingly, the relevant descriptions of such features apply equally to the features of the detachable bed rail 200 and related components depicted in FIG. 8. Any suitable combination of the features, accessories, and variations of the same, described with respect to the detachable bed rail 100 and related components illustrated in FIGS. 1-7 can be employed with the detachable bed rail 200.

The detachable bed rail 200 may comprise a base portion 201 that in many respects resembles the base portion 101. In some embodiments, the base portion 201 may be identical to and interchangeable with the base portion 101. Similarly, the detachable bed rail 200 may comprise a support rail portion 210 that in many respects resembles the support rail portion 110. In some embodiments, the support rail portion 210 may comprise identical features and components of the support rail portion 210. In the current embodiment, the support rail portion 210 is identical to the support rail portion 110 except that the length of the support rail portion 210 is shorter than the length of the support rail portion 110. The length L200 of the support rail portion 210 may be between 260 and 280 mm. In other embodiments, the length L200 of the support rail portion 210 may be between 250 and 300 mm or 250 and 400 mm.

The detachable bed rail 200 may comprise the same or similar optional accessories to enhance or add functionality to the detachable bed rail 200 as are described in relation to detachable bed rail 100 and depicted in FIGS. 5A-D, 6A-D, and 7.

While specific embodiments of detachable bed rails have been illustrated and described, it is to be understood that the invention claimed hereinafter is not limited to the precise configuration and components disclosed. Various modifications, changes, and variations apparent to those of skill in the art may be made in the arrangement, operation, and details of the methods and systems disclosed.

Without further elaboration, it is believed that one skilled in the art can use the preceding description to utilize the present disclosure to its fullest extent. The examples and embodiments disclosed herein are to be construed as merely illustrative and exemplary and not a limitation of the scope of the present disclosure in any way. It will be apparent to those having skill in the art that changes may be made to the details of the above-described embodiments without departing from the underlying principles of the invention as claimed hereinafter. In other words, various modifications and improvements of the embodiments specifically disclosed in the description above are within the scope of the appended claims. Note that elements recited in means-plus-function format are intended to be construed in accordance with 35 U.S.C. § 112 ¶6.

1. A mobility assistance device to provide support for a user on a bed or similar furniture, comprising:
a base portion configured to be disposed under a mattress of the bed; and
a support rail portion coupleable to the base portion in a first configuration configured to extend above a top surface of the mattress,
wherein the support rail portion is configured to be disposed in a second configuration below the top surface of the mattress.

2. The assistance device of claim 1, wherein the base portion and the support rail portion are disposed in a substantially orthogonal orientation relative to each other in the first configuration.

3. The assistance device of claim 1, wherein the support rail portion is coupled to the base portion in the first configuration such that movement of the support rail portion relative to the base portion is inhibited.

4. The assistance device of claim 1, wherein the support rail portion comprises a perimeter, and
wherein a portion of the perimeter comprises a compound curved surface having a radius of curvature of at least 14 mm in a first direction and a radius of curvature of at least 130 mm in a second direction.

5. The assistance device of claim 1, wherein the support rail portion comprises a plurality of horizontal and vertical rails coupled to each other.

6. The assistance device of claim 1, wherein when in the first and second configurations, the support rail portion is disposed in the same relative orientation.

7. The assistance device of claim 1, wherein the support rail portion is coupled to the base portion in the first configuration at a single point of engagement.

8. The assistance device of claim 1, wherein the base portion comprises a first coupling member, and the support rail portion comprises a second coupling member, and wherein one of the first and second coupling members comprises a post portion and the other coupling member comprises a post receiving portion.

9. The assistance device of claim 8, further comprising a securement member configured to inhibit separation of the first coupling member from the second coupling member in the first configuration.

10. The assistance device of claim 9, wherein the securement member comprises a flexible strap.

11. The assistance device of claim 8, wherein the support rail portion is symmetrical about a vertical axis extending through the second coupling member when the support rail portion is disposed in the first configuration.

12. The assistance device of claim 1, further comprising an attachment member configured to secure the base portion to the bed.

13. The assistance device of claim 1, wherein the support rail portion is coupled to the bed in the second configuration.

14. The assistance device of claim 13, further comprising a bed engagement feature for coupling of the support rail portion to the bed in the second configuration.

15. The assistance device of claim 1, further comprising a rail cover coupled to the support rail portion and configured to cover a least a portion of the support rail portion.

16. The assistance device of claim 1, further comprising a tray table member removably coupleable to the support rail portion.

17. The assistance device of claim 1, further comprising an extension member coupleable to the support rail portion configured to extend the length of the support rail portion.

18. A method of using a detachable bed rail comprising:
obtaining a detachable bed rail configured to provide support for a user on a bed, the assistance device comprising a base portion and a support rail portion coupled to the base portion;
disposing the base portion underneath a mattress of the bed such that the support rail portion extends upright adjacent the bed; and
decoupling the support rail portion from the base portion.

19. The method of claim 18, further comprising;
coupling the support rail portion to the bed after decoupling it from the base portion.

20. The method of claim 18, further comprising:
decoupling the support rail portion from the bed and coupling the support rail portion to the base portion.

21. A detachable bed rail to provide support for a user on a bed or similar furniture, the detachable bed rail comprising:
a base portion configured to be disposed under a mattress of the bed; and
a support rail portion coupled to the base portion,
wherein the support rail portion is configured to couple to the bed when decoupled from the base portion.
